(19) United States
(12) Patent Application Publication
(10) Pub. No.: US 2025/0306715 A1
(43) Pub. Date: Oct. 2, 2025

(54) METHOD FOR PRODUCING ANDROID DEVICE TEST REPRODUCIBLE ON ANY ANDROID DEVICE AND METHOD FOR REPRODUCING AN ANDROID DEVICE TEST

(71) Applicant: SAMSUNG ELETRÔNICA DA AMAZÔNIA LTDA., MANAUS AM (BR)

(72) Inventors: YADINI PÉREZ LÓPEZ, MANAUS / AM (BR); DOUGLAS QUEIROZ BATISTA, MANAUS / AM (BR); GILMAR JÓIA DE FIGUEIREDO COSTA JUNIOR, MANAUS / AM (BR); DANIEL LOPES XAVIER, MANAUS / AM (BR); LETICIA BALBI, MANAUS / AM (BR)

(73) Assignee: SAMSUNG ELETRÔNICA DA AMAZÔNIA LTDA., MANAUS AM (BR)

(21) Appl. No.: 18/936,393

(22) Filed: Nov. 4, 2024

(30) Foreign Application Priority Data
Mar. 22, 2024 (BR) 10 2024 005710 4
Aug. 27, 2024 (BR) 10 2024 017553 0

(51) Int. Cl. G06F 3/041; G06F 3/042; G06V 10/764; G06V 10/82; G06V 20/40; G06V 30/19; G06V 40/20

(52) U.S. Cl. CPC G06F 3/04186; G06F 3/0425; G06V 10/765; G06V 10/82; G06V 20/41; G06V 30/19153; G06V 40/28; G06V 2201/02

(57) ABSTRACT

A method for producing android device test reproducible on any android device, comprising: receiving a previously recorded android test video file and processing the video file to extract video frames; searching for touch coordinates in the video frames; identifying the touch coordinates in the video frames and generating touch coordinate groups. The method includes translating touch coordinate groups into android actions using heuristic rules; recognizing and classifying widgets in the android actions video frames; generating a description for each of the recognized and classified widgets; associating a widget with each android action; generating a user-readable test step text file and a test step file with detailed information for each step, and iteratively founding the most similar widget on the device under test screen when compared with the human-readable described step at each timestamp at execution time.

### CROSS-REFERENCE TO RELATED APPLICATION(S)

This application is based on and claims priority under 35 U.S.C. § 119 to Brazilian Patent Application No. 10 2024 005710 4, filed on Mar. 22, 2024, and Brazilian Patent Application No. 10 2024 017553 0, filed on Aug. 27, 2024, in the Brazilian Intellectual Property Office, the disclosures of which are incorporated by reference herein in their entireties.

### TECHNICAL FIELD

The present invention relates to a method for producing android device test and a method for reproducing android device test.

### BACKGROUND OF THE INVENTION

Record and Replay (R&R) testing tools aim to automate android testing by recording a test video and playing it back later. Usually, test video scripts are automatically generated from information captured during test video recording. However, current solutions extract information relevant to interpreting the test video from application metadata, which increases maintenance frequency as metadata often changes between application versions and physical android devices. While there are some tools that solve this problem by extracting and processing data using machine learning techniques, none of the approaches overcome changes in application versions across devices, called fragmentation, entirely.

Most R&R tools available use heuristic algorithms to analyze recorded metadata and interpret the actions performed during playback of test videos. Currently, few tools use computer vision techniques, such as object detection and image classification, to interpret steps from recorded test videos. Furthermore, as already mentioned, the prior art does not solve the problem of fragmentation.

The prior art comprises several R&R tools such as MOSAIC (Halpern, Zhu, Peri, & Reddi, 2015), Barista (Fazzini, Freitas, Choudhary, & Orso, 2017), Robotium (Robotium, 2022), Test Recorder Esspresso (Esspresso), XAMARIN (Xamarin), Appetizer (AppetizerIO, 2023), Bot-Bot (Bot-Bot, 2023), Culebra (Culebra, 2023), MonkeyRunner (MonkeyRunner, 2023), Ranorex (Ranorex, 2023), RERAN (L. Gomez, 2017), VALERA (Y. Hu, 2017). However, these tools lack of test case portability and require manual definition of the oracle's assertiveness, which can be time-consuming. Furthermore, most of these tools require different device pre-configurations to record the test video, which can be inconvenient for programmers and testers as they prefer tools with minimal recording configuration.

The V2S technique (Bernal-Cardenas, et al., 2020) is also a R&R android testing tool that can generate test scripts from recorded android test videos and run these scripts later on the same device model where the test video it was recorded. The main contribution of the V2S technique when compared to the previously mentioned R&R tools is that it can play back a recorded test video using only visual information to interpret the steps performed in the test video. In other words, since the V2S technique does not rely on any metadata information, it substantially minimizes the recording configuration. However, V2S still lacks portability as it is coordinate-sensitive. In other words, the touch recognition model must be trained on each device model to tune the knowledge to specific videos and resolutions, which can be time-consuming and almost impractical.

Document GifDroid (Sidong Feng, 2022); presents a tool for the automated reproduction of visual Bugs for Android applications. This tool uses image similarity to detect keyframes in a test video record. It then performs a graphical user interface (GUI) mapping to generate the transition graph. This approach uses the pixel distribution of the screenshot to find keyframes, making the tool sensitive to dynamic content and device-app-release fragmentation.

Document US 2022/0171510 A1, published on Jun. 2, 2022, in the name of T-MOBILE USA, INC., and entitled “AUTOMATED TESTING OF MOBILE DEVICES USING BEHAVIORAL LEARNING” describes techniques that can be used to automate testing of services on mobile devices using visual analytics. In some embodiments, a behavioral model or other machine learning model is trained using training data collected while testers use mobile devices to test the services. When running a test routine on a mobile device, screenshots of a mobile device screen are taken and fed to the machine learning model. The behavioral model or other machine learning model may use the provided screenshot to determine an action that simulates a user action (e.g., a user tap on the mobile device screen) at the location of an icon or other visual element associated with routine testing. These steps are repeated until the final state of the test routine is detected.

Document U.S. Pat. No. 11,567,858 B2, published on Jan. 31, 2023, in the name of APPTEST. AI, and entitled “SYSTEM AND METHOD FOR USER INTERFACE AUTONOMOUS TESTING” describes a system and method capable of automatically testing a website or application for errors in the user interface, without human intervention. For example, in a system for testing an error in a user interface of an application or website, a user interface system that includes a testable action recognizer that takes a screenshot of a screen of the application or website, manages a layout, and a test action based on the user interface (UI) configuration and text recognition information from the screenshot, and a test action generator that receives the layout, select a test scenario corresponding to the layout, and performs a test action according to the test scenario, and in which the testable action recognizer manages whether or not a test progresses for each screen layout according to the test scenario.

Document U.S. Pat. No. 10,853,232 B2, published on Dec. 1, 2020, in the name of SPIRENT COMMUNICATIONS, INC., and entitled “ADAPTIVE SYSTEM FOR MOBILE DEVICE TESTING” describes systems, methods, and devices for creating a system for monitoring and reporting performance of test that is adaptable for use with different types of mobile devices. The test performance monitoring and reporting system adapts to be interoperable with different mobile device models by combining sequences of deterministic logic blocks with device-specific asset libraries. Logic blocks can be added to or removed from the sequence. Logic blocks implement different mobile device operations, including using assets, launching applications, and replaying sequences of recorded command interface interactions from test users. The asset library contains assets corresponding to mobile device elements that can be manipulated by users. These assets are device-specific, and a test script can be adapted to suit a specific mobile device model by replacing existing assets in the script with assets from the specific mobile device's asset library.

However, a problem with the prior art is the fact that currently available solutions use metadata information from the user interface (UI) and the event system to identify actions. These solutions are not able to overcome changes in application versions across devices, i.e., fragmentation, regarding UI and device resolution.

Another problem with the prior art is the fact that current R&R tools can validate changes between devices with respect to resolution, but when it comes to changes between versions, these tools perform poorly. User interface changes from one android device to another can be very diverse in nature, from semantic changes of textual widgets to location changes of widgets.

### SUMMARY

An objective of the present invention is to provide a method for producing android device test reproducible on any android device and a method for reproducing an android device test that solves the problems of the prior art.

This objective is achieved by means of a method for producing android device test reproducible on any android device, comprising: receiving a previously recorded android test video file and processing the video file to extract video frames; searching for touch coordinates in the video frames; identifying touch coordinates in the video frames; generating touch coordinate groups; translating touch coordinate groups into android actions using heuristic rules; detecting and classifying widgets on key video frames; generating a description for each of the detected and classified widgets by extracting information from those widgets; associating a widget with each android action, wherein the associated widget is the widget that is closest to the android action; and generating a user-readable test text file and a test step file with detailed information for each step.

Conveniently, the method according to the present invention may search for touch coordinates in the video frames with the Screen2Text and V2S techniques.

The method according to the present invention further may terminate the method, provided the search for touch coordinates in the video frames does not find anything.

Furthermore, the method according to the present invention may include identifying the touch coordinates in the video frames that further comprises: using a V2S touch coordinate identification technique; and if the V2S touch coordinate identification technique fails, using the Screen2Text technique to identify touch coordinates.

Additionally, the method according to the present invention further comprises, after identifying the touch coordinates in the video frames, analyzing all video frames to verify which touch coordinates represent touch; and discarding frames that do not belong to any frame group with screen interaction.

Conveniently, the method according to the present invention, the generated touch coordinate groups comprise the name of the video frames and the touch coordinates identified in the video frames by the V2S and Screen2Text techniques.

The method according to the present invention further includes translating touch coordinate groups into android actions using heuristic rules, that further comprise: grouping consecutive video frames into a touch coordinate group, comprising an initial video frame and a final video frame; identifying the touch coordinates of the initial video frame and the touch coordinates of the final video frame of said touch coordinate group, to calculate the Euclidean distance between the touch coordinates of the initial and final video frame of the touch coordinate group.

The method according to the present invention may further include, when the number of consecutive video frames is less than five or if the Euclidean distance is less than thirty units, determining the translation is a click action.

The method according to the present invention may further include, when the number of consecutive video frames is greater than five or if the Euclidean distance is greater than thirty units, determining the translation is a long click, swipe, or drag-and-drop action.

Furthermore, in the method according to the present invention, the translation is a swipe action when the number of video frames of the touch coordinate group is smaller than the minimum number of frames for a group being translated as a long click action and the distance between the coordinates of the initial and final video frame of the touch coordinate group is greater than 30 units, the translation is also a swipe action when the number of frames of the touch coordinate group is greater than the minimum number of frames for a group being translated as a long click action and the Euclidean distance between the coordinate of the initial and final video frame of the minimum to be a long click is greater than 70 units; or the translation is a long click action when the number of video frames of the touch coordinate group is greater than the minimum number of frames for a group being translated as a long click action and the Euclidean distance between the coordinate of the initial and final video frame of the minimum to be a long click is smaller than 70 units and the distance between the initial and final coordinate of the non-minimum to be a long click is smaller than 30 units; or the translation is a drag-and-drop action when the number of video frames of the group is greater than the minimum number of video frames for a group being translated as a long click action and the Euclidean distance between the coordinate of the initial and final video frame of the minimum to be a long click is smaller than 70 units and the distance between the initial and final coordinate of the non-minimum to be a long click is greater than 30 units.

Additionally, in the method according to the present invention, recognizing and classifying widgets in the android actions video frames, further comprises: using the find contours technique to find areas of interest with a high probability of being widgets; and using a three-layer convolutional neural network to classify each area of interest into one of one hundred and six widget interest classes.

Conveniently, in the method according to the present invention,, generating a description for the recognized and classified widgets, further comprises: using a text recognition technique in case the widget is a text button, text or list item, to extract text information; using an image recognition technique, in case the widget is an image, card or video thumbnail, to extract image information; and using widget assignment rules, which assign to widgets the description of the nearest horizontally or vertically aligned textual element in case the widget is not recognized by the text recognition technique or the image recognition technique, for example: switch, check box, slider and radio button

In the method according to the present invention, the user-readable test step text file comprises Android actions and widget descriptions; and the test step file with detailed information of each step comprises the preconditions for carrying out the test, such as the device language, the screen mode and whether the navigation bar is active or not, and the steps that were performed in the video and translated into actions.

The present invention also provides a method for reproducing an android device test, wherein it uses the user-readable test step text file or the test step file with detailed information of each step, comprising: selecting the test by widget; identifying widgets present on the android device screen at a given time; and finding and matching a widget on the android device screen at a given time to the widget present in the executed test step of the file.

Furthermore, in the method according to the present invention, finding and matching a widget on the android device screen at a given time to the widget present in the test step executed of the file, further comprises: comparing if the class and description of a widget on the android device screen at a given time is the same as the class and description of the widget present in the executed test step of the file.

Additionally, in the method according to the present invention, when a widget on the android device screen at a given time has the same class and description as the widget present in the executed test step of the file, these widgets are corresponding.

Conveniently, the method according to the present invention, when no widget on the android device screen at execution time has the same class and description as the widget present in the executed test step of the file, the method further comprises: comparing the class and description of the widgets on the android device screen at the given time with the class and description of the widget present in the executed test step of the file to check semantic similarity between the classes and descriptions of the widgets on the android device screen at the given time and the widget present in the executed test step of the file, so that if the semantic similarity result is greater than or equal to 0.96 then there is a widget on the android device screen at the given time corresponding to the widget present in the executed test step of the file.

An advantage of the present invention, among others, include includes using Computer Vision techniques to interpret steps from recorded testing videos. Specifically, Object Recognition and Optical Character Recognition (OCR) are used to find the coordinates of the actions executed in each video frame. Image Recognition and Natural Language Processing techniques are used for identifying each action executed with the widget actioned, mimicking the human association on software interaction. In the present invention, once a touch or user interaction is detected in a video frame, Image Recognition+OCR are used to get the widget description. Hence, the present invention not only detects the action coordinates (as state of art tools does) but is also able to improve the action recognition performance and get the description of the actioned widget, which results in portable and human-readable steps.

An additional advantage of the present invention includes the fact that generates “portable” step sequences that can be executed successfully in different device models and application versions, overcoming the fragmentation problem. Also, the present invention can generate human readable steps, since it can recognize not only the coordinates where an action was executed in the video but also the android component that was actioned.

Other advantages of the present invention includes the fact that it uses only visual information. The present invention does not base the recognition only on the interaction's coordinates. Instead, the present invention recognizes the touch coordinate in the video and then associates a GUI component to it. By generating widget-based steps, the present invention potentiates cross-device-app portability. Also, the present invention uses semantic similarity to validate release changes on textual widgets that can impact the result when comparing the inferred step from the recorded video with all the available widgets on a screen capture at reproduction time. Finally, the present invention demands minimal recording pre-configurations which is a desirable feature for any test automation method.

### BRIEF DESCRIPTION OF THE DRAWINGS

The objects and advantages of the present invention will become clearer through the following detailed description of the examples and non-limiting drawings presented at the end of this document:

FIG. 1 is a flowchart illustrating the method for producing an android device test reproducible on any android device, according to a preferred embodiment of the present invention.

FIG. 2A is a flowchart illustrating the translation of the touch coordinate groups into android actions using heuristic rules, according to an embodiment of the present invention.

FIG. 2B is an alternative illustration of the action translation portrayed on the flowchart according to an embodiment of the present invention.

FIG. 3 is a flowchart illustrating the widget detection, classification, and smart description generation. This smart description relies on the widget type for selecting the proper technology for extracting semantic information from the image to describe a widget, according to an embodiment of the present invention.

FIG. 4 illustrates the Find Contours technique after Canny filter and morphological closing application according to an embodiment of the present invention.

FIG. 5A illustrates the Text Recognition and Image Recognition Techniques of the method according to an embodiment of the present invention.

FIG. 5A illustrates the result according to an embodiment of the present invention.

FIG. 6 illustrates the list of widgets generated according to a preferred embodiment of the present invention.

FIG. 7 is a flowchart illustrating the method for reproducing an android device test, according to a preferred embodiment of the present invention.

FIG. 8 illustrates the use of the Screen2Text technique according to a preferred embodiment of the present invention.

FIG. 9 illustrates the use of the V2s technique according to a preferred embodiment of the present invention.

### DETAILED DESCRIPTION

Although the present invention may be susceptible to different embodiments, a preferred embodiment is shown in the following detailed discussion with the understanding that the present description should be considered an exemplification of the principles of the invention and that the present invention is not intended to be limited to what has been illustrated and described here.

[TEST PRODUCTION]

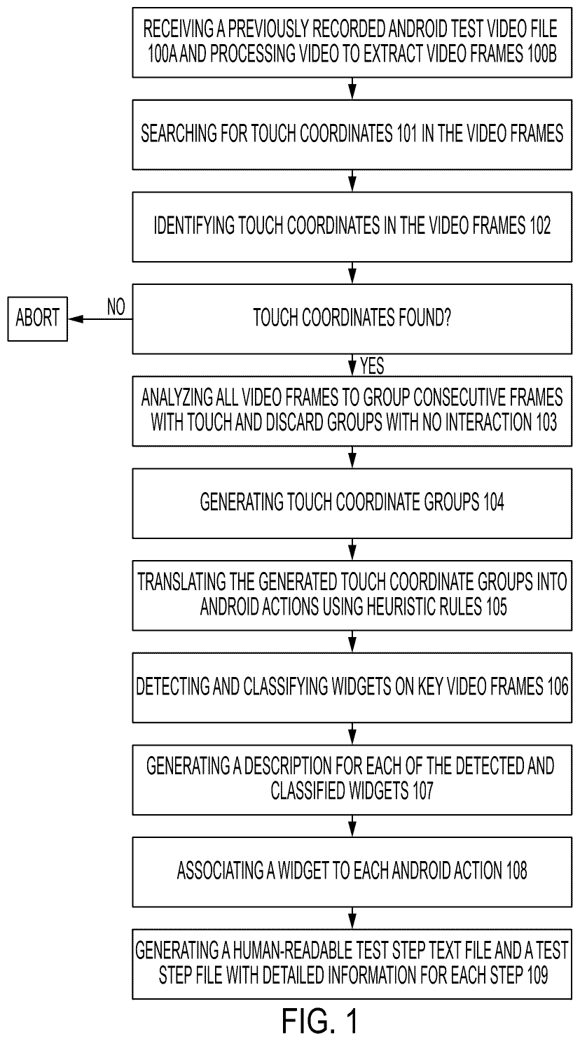

According to FIG. 1, the method for producing an android device test reproducible on any android device starts receiving 100A a previously recorded android test video file and processing 100B such video to extract video frames.

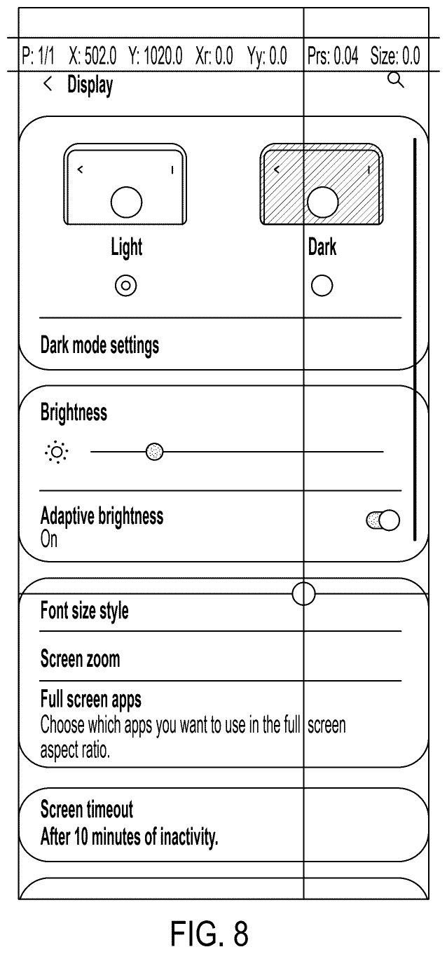

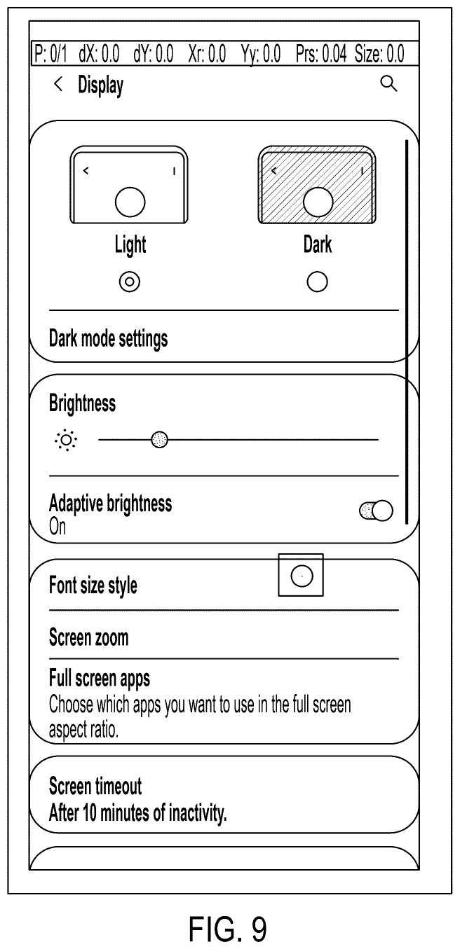

Still according to FIG. 1, the method then searches 101 for touch coordinates in the video frames, wherein said search 101 is carried out using the V2S and Screen2Text techniques. The Screen2Text technique reads the touch information present in the “Pointer Locator” status bar, visible when the “developer mode-pointer locator” is activated on the device, as illustrated in FIG. 8. The V2S technique detects the “touch icon” (usually a circle) that appears on the screen when a finger touches the screen, visible when the “developer mode” is activated in the device, as illustrated in FIG. 9. First, the Screen2text technique is used, if is detected a touch coordinate, then, the V2S technique is used for accurately recognizing the touch interaction area (bounding box). The decision to apply Screen2text first and then V2S, was because, on early evaluation of both methods on the same annotated dataset, the Screen2text method showed better recall whereas the v2s technique presented higher precision.

In case the search 101 for touch coordinates does not find anything, the method is terminated.

The method then identifies 102 touch coordinates in the video frames. Identification 102 is carried out using the V2S touch coordinate identification technique, and if the V2S touch coordinate identification fails, the technique identification is carried out using the Screen2Text technique to identify touch coordinates.

After identifying 102 the touch coordinates on the video frames, the method then analyzes 103 all the video frames for those that do not have touch coordinates and then deletes them, keeping only the groups of consecutives frames that contain traceable coordinates of screen interaction. Therefore, the method analyzes 103 all video frames to verify which touch coordinates represent touch and discards video frames that do not belong to any video frame group with screen interaction.

The method then generates 104 touch coordinate groups, which comprise the name of the video frames (e.g.: 001, 002, 003, . . . ) and the touch coordinates identified 102 in the frames by the V2S and Screen2Text techniques.

The method then translates 105 the generated touch coordinate groups into android actions using heuristic rules. Currently, there are four possible types of actions that can be translated from touch groups: click, long click, swipe, and drag-and-drop. The click action is usually an action with the smaller number of grouped frames (one to five frames), the long click action groups more than five frames and the initial and final touch coordinates of the touch coordinate groups are close. The swipe action is also compounded by more than five grouped frames, but the initial and final coordinates are distant, and the drag-and-drop action combines a long click and a swipe, being compound by more than five grouped frames and a large difference between the initial and final touch coordinates.

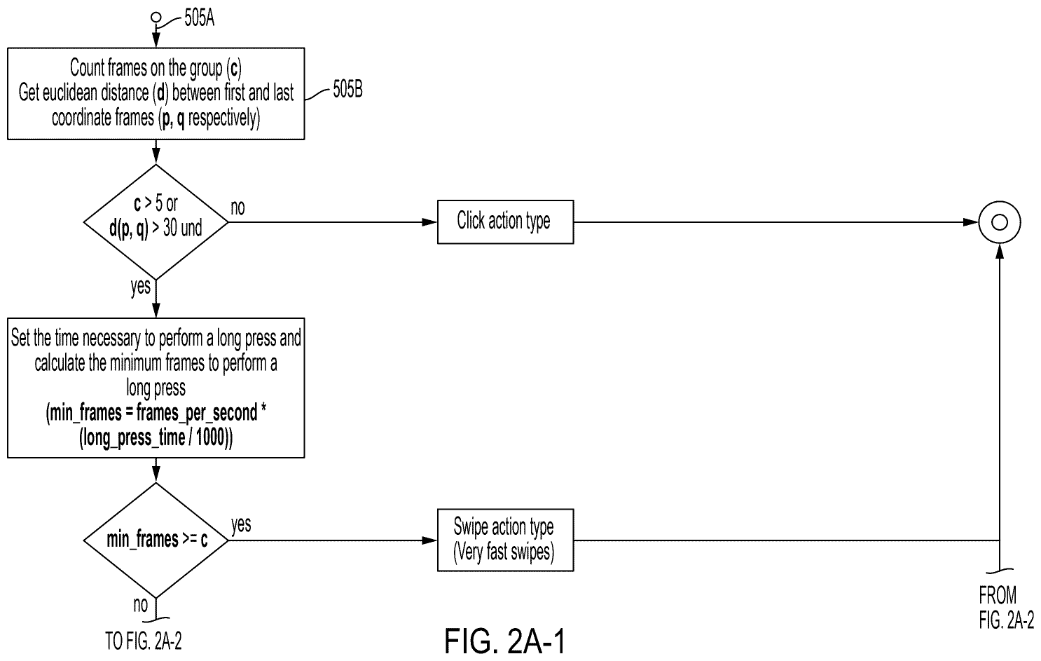

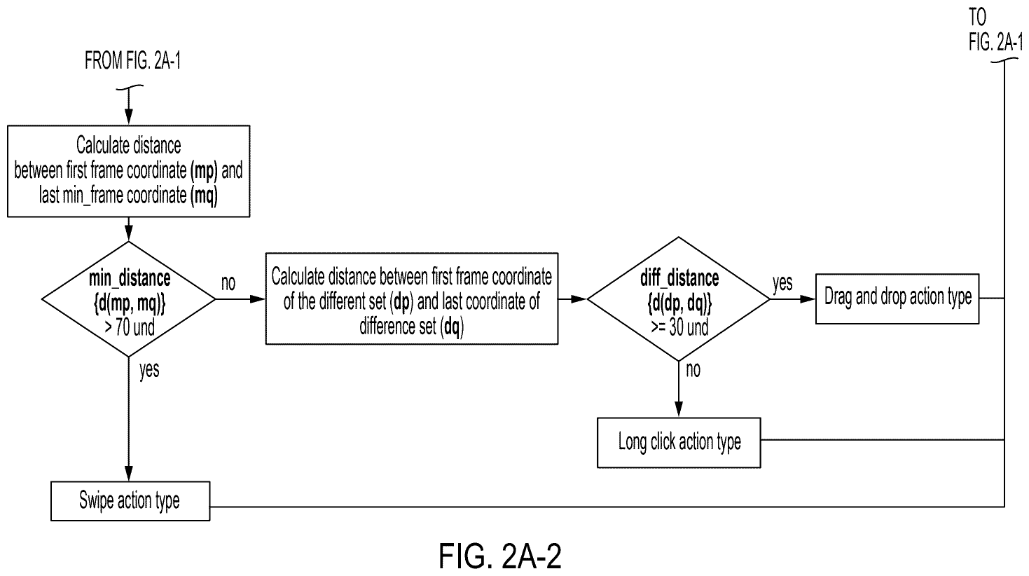

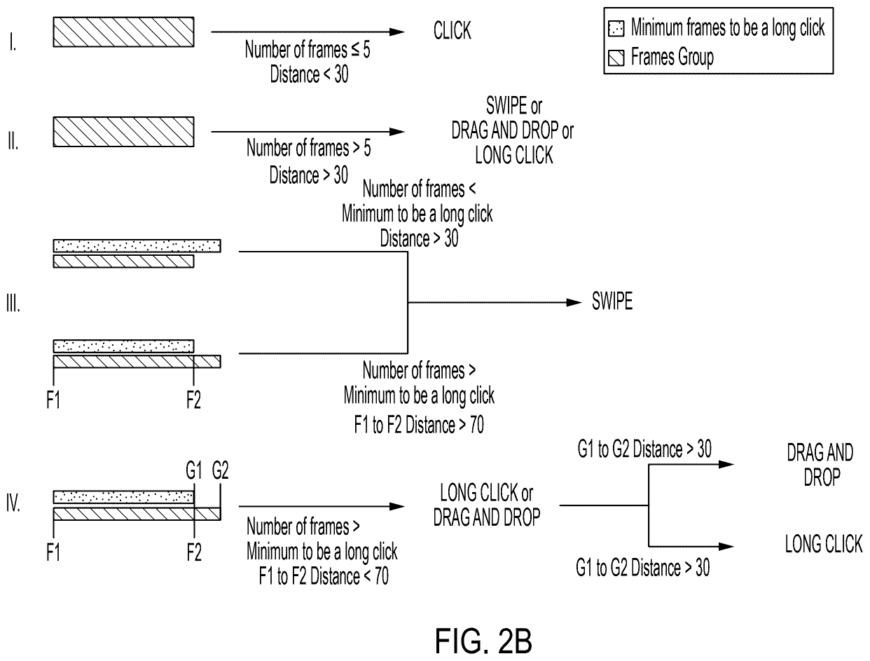

According to FIG. 2, the translation 105 of the generated touch coordinate groups into android actions using heuristic rules comprises grouping 105A consecutive video frames into a touch coordinate group comprising an initial video frame and a final video frame, wherein a touch coordinate group is closed when the next video frame that presents coordinates with null values and a new touch coordinate group is created from the next video frame with non-zero coordinates. Translation occurs by identifying 105B the touch coordinates of the initial video frame and the touch coordinates of the final video frame of the touch coordinate group, to calculate a Euclidean distance between the touch coordinates of the initial and final video frame of said group. As it is known, the Euclidean distance is used to find the distance between two points on a plane.

Regarding this, if the number of consecutive video frames is less than five or if the Euclidean distance is less than thirty units, the translation is a click action, or if the number of consecutive video frames is greater than five or if the Euclidean distance is greater than thirty units, the translation can be either a long click, swipe, or drag-and-drop action.

As shown in FIG. 2B, I, a click is characterized by having 1 to 5 consecutive video frames with Euclidean distance between the initial coordinate (first video frame of the touch coordinate group) and the final coordinate (last video frame of the touch coordinate group) smaller than 30 units. To determine if a touch coordinate group of video frames represents a long click, a swipe, or a drag and drop action II it is necessary to find the minimum pressing time required for executing a long click. Usually, this value is 0.5 seconds. Hence, the minimum number of video frames necessary to execute a long click action is equivalent to the frames per second constant times the long click pressing time constant (0.5). Then, if the number of actual video frames is smaller than the minimum number of video frames to be a long click on the touch coordinate group and the Euclidean distance between the initial and final touch coordinates is greater than 30 units, then the touch coordinate group is translated as a swipe (very fast executed), III. A touch coordinate group can also represent a swipe action when the number of video frames is greater than the minimum number of video frames for being a long click and the Euclidean distance between the first coordinate III-F1 and the last coordinate III-F2 of the minimum to be a long click is greater than 70 units (regular swipe). On the other hand, if the mentioned minimum Euclidean distance to be a long click is smaller than 70 units and the number of video frames is greater than the minimum number of video frames for being a long click, then the touch coordinate group can be translated as a drag-and-drop or long click action IV. Here, is analyzed the Euclidean distance between the first coordinate IV-G1 and the last coordinate IV-G2 of the non-minimum to be a long click long click. If this distance is greater than 30 units then, the touch coordinate group is a drag-and-drop, or a long click, otherwise. The 30 and 70 distance thresholds were defined empirically, through different iterations of running and analyzing the results. The equation I below summarizes the logic for determining the classification of a group of frames with interaction coordinates.

Alternatively, the logic for translating a touch group to an Android action can be formulated, as follows:

Having that,

$$d ( p , q ) = {\sqrt{\sum ( {q}_{i} - {p}_{i} )}}^{2} \qquad ( I )$$

where, d (p,q) is the Euclidean distance between p and q; p is the point that represent the coordinates of the first frame on a frame group and q is the coordinates of the last frame on a frame group.

$$min\_frames = frames\_per \_second * ( long\_press \_time / 100 ) \qquad ( II )$$

where, min_frames is the number of frames for a group being translated as a LONG_CLICK; frames_per_second is the number of frames per second original configuration of the video recorded; long_press_time is the time in milliseconds (ms) configured on the Device Under Test (DUT) for an interaction with the screen being considered as a long click.

$$min\_distance = \sqrt{\sum {( {mq}_{i} - {mp}_{i} )}^{2}} \qquad ( III )$$

where, mq; and mp; represent the coordinates of the first and last frames on the min_frames set respectively; and, min_distance is the Euclidean distance between mq; and mp; points.

$$diff\_frames = c - min\_frames \qquad ( IV )$$

where, diff_frames is the difference of the total number of frames on the group (c) and min_frames is the minimum number of frames for a group being translated as a long click action.

$$diff\_distance = \sqrt{\sum {( {dq}_{i} - {dp}_{i} )}^{2}} \qquad ( V )$$

where, dq; and dpi are the coordinates of the first and last frames on the diff_frames set respectively; and diff_distance is the Euclidean distance between dq; and dpi.

```
Then,
IF not c > 5 or d(p,q) > 30
  Then, frame_group is a CLICK
ELSE
  IF min_frames ≥ c
    Then, frame_group is a SWIPE
  ELSE
    IF min_distance ≥ 70
        Then, frame_group is a SWIPE
    ELSE
      IF diff_distance ≥ 30
          Then, frame_group is a DRAG_AND_DROP
      ELSE
          Then, frame_group is a LONG_CLICK
```

According to FIG. 1, the method then detects and classifies 106 widgets on key video frames. A key video frame is the first frame of each group that defines an Android action.

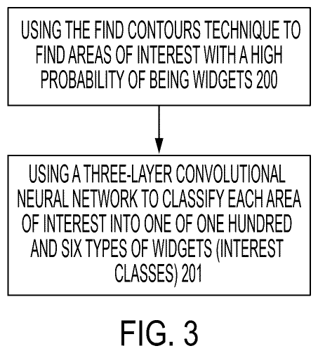

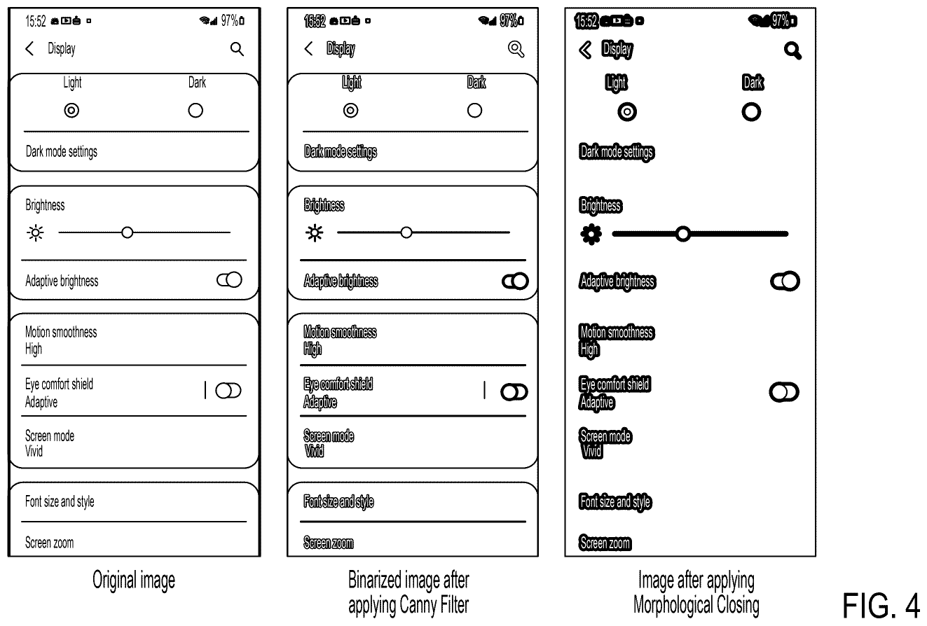

In this sense, according to FIG. 3, in order to detect and classify 106 the widgets, the method then uses 200 the Find Contours technique, illustrated in FIG. 4, which comprises of (i) converting images to gray scale (black and white), (ii) applying the Canny edge filter to highlight the edges of the image components and (iii) applying the morphological closing technique, where parts of the image that contain noise are removed without the information being discarded. Thus, it is used to find areas of interest with a high probability of being widgets, and then uses 201 a three-layer convolutional neural network to classify each area of interest into one of the one hundred and six classes of interest (button, text, image, card, etc.). To perform the classification, it was created a variation of Rico dataset composed by the one hundred and six classes of widgets, including ninety-eight different types of icons. This dataset was used to train the three-layer convolutional neural network model. For each class, the characteristics of the widgets are learned layer by layer of the neural network, and, as output, there is a number in the range from 0 to 105 that indicates the class that the image belongs to (for example: the “Button” class is represented by the number 0; therefore, when an image of this class is inserted, it is expected that convolutional neural network will return the number 0 as output).

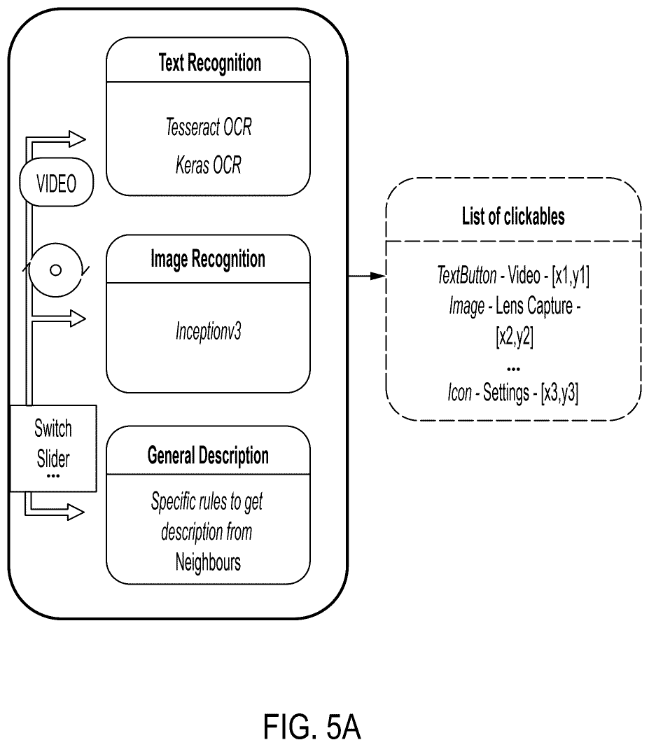

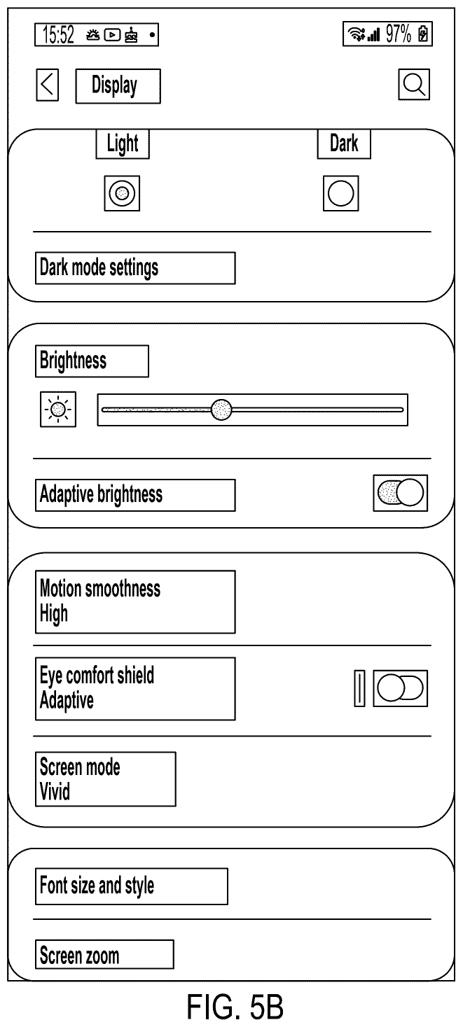

Further according to FIG. 1, the method then generates 107 a description for each of the detected and classified widget by extracting information from those widgets. As shown in FIG. 5A, generation 107 is carried out with the steps of using a text recognition technique in case the widget is a text button, text, or list item, to extract text information, using an image recognition technique, in case the widget is an image, card or video thumbnail, to extract image information, and using widget assignment rules, which assign to widgets the description of the nearest horizontally or vertically aligned textual element (description or name of a clickable element on the screen), in case the widget is not recognized by the text recognition technique or the image recognition technique (a switch, radio button, checkbox, slider or any other type of widget without own description), and the method uses the actual class in case the widget is classified as an icon. Since, the method can recognize ninety-eight types of icons, i.e., icon-more, icon-favorite, etc.

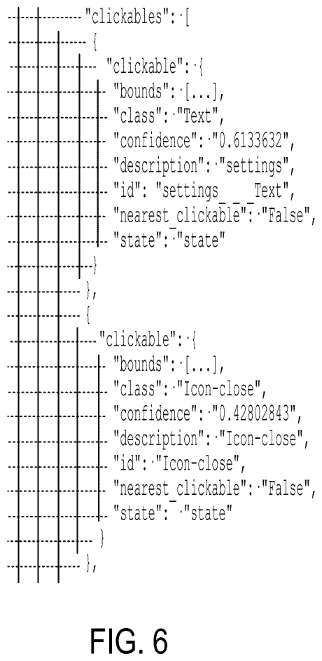

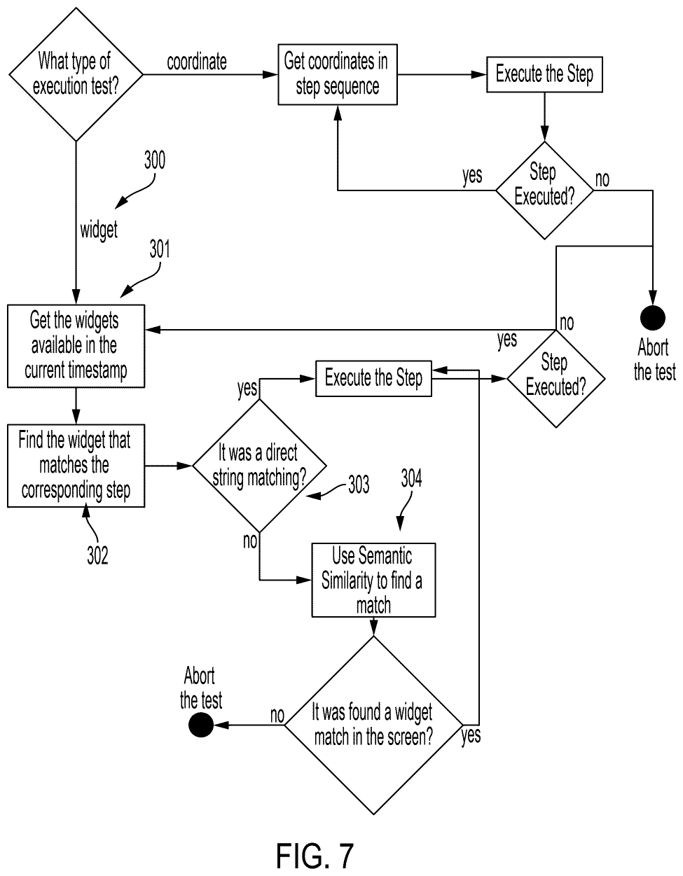

The proposed method can fully recognize widgets of different natures, as shown in FIG. 5B. The generation 107 is a list of the widgets saved in a JSON file, illustrated in FIG. 6, that describes features of said widget, such as type, coordinate, class to which it belongs, and the description assigned to it.

According to FIG. 1, the method then associates 108 a widget with each android action, wherein the associated widget is the widget that is closest to the android action.

The method then generates 109 a user-readable test step text file and a test step file with detailed information for each step, wherein the user-readable test step text file comprises android actions and widget descriptions, and the test step file with detailed information of each step comprises the preconditions for carrying out the test, such as the device language, the screen mode and whether the navigation bar is active or not, and the steps that were performed in the video and translated into actions. Each step has action description information, the action type and clickable information, such as position, class, and description.

After the execution of step 109 the test producing is finished, and the outputs are the test step text file and the test step file with detailed information for each step. These files are reproducible on any android device under test.

[TEST REPRODUCTION]

According to FIG. 8, the method for reproducing an android device test uses the user-readable test step text file or the test step file with detailed information of each step and starts selecting 300 the test by widget. The present invention can also reproduce the actions performed in a video with the option of testing by coordinates, used as a default if the test type argument is not specified.

The method then identifies 301 widgets present on the android device screen at a given time and proceeds to find and match 302 widgets on the android device screen at a given time to the widget present in the executed test step of the file.

According to the present invention, finding and matching 302 a widget on the android device screen at a given time to the widget present in the test step executed of the file comprises comparing 303 if the class and description of a widget on the android device screen at a given time is the same as the class and description of the widget present in the executed test step of the file.

In this sense, if a widget on the android device screen at a given time has the same class and description as the widget present in the executed test step of the file, these widgets are corresponding.

However, if no widget on the android device screen at a given time has the same class and description as the widget present in the executed test step of the file, the method further comprises the step of comparing 304 the class and description of all widgets on the android device screen at the given time with the class and description of the widget present in the executed test step of the file to check semantic similarity between the classes and descriptions of the widgets on the android device screen at the given time and the widget present in the executed test step of the file, so that if the semantic similarity result is greater than or equal to 0.96, then there is a widget on the android device screen at the given time corresponding to the widget present in the executed test step of the file. Semantic similarity comprises of verifying how close are two texts represented as vectors on a vectorial space. In the present invention, it is used the cosine similarity method for calculating the distance between two vectorial representations of texts also called embeddings. This, in turn, has weights that may or may not approximate one textual term to another through the calculation of Cosine Similarity, which returns 1 if two terms are 100% similar and can vary between negative and positive values close to 1.

In addition to the embodiments presented above, the same inventive concept may be applied to other alternatives or possibilities for using the invention.

Although the present invention has been described concerning certain preferred embodiments, it is not intended to limit the invention to those embodiments. Rather, it is intended to cover all possible alternatives, modifications and equivalences within the spirit and scope of the invention, as defined by the appended claims.

What is claimed is:

1. A method of producing an android device test reproducible on any android, comprising:
receiving a previously recorded android test video file and processing the previously recorded android test video file to extract video frames;
searching for touch coordinates in the video frames;
identifying the touch coordinates in the video frames;
generating touch coordinate groups from consecutive frames with touch identified;
translating the touch coordinate groups into android actions using heuristic rules;
detecting and classifying widgets on key video frames;
generating a description for each of the detected and classified widgets by extracting information from the widgets;
associating a widget with an android action, the associated widget being the widget that is closest to the android action; and
generating a user-readable test step text file and a test step file with detailed information for each step.

2. The method as in claim 1, wherein the searching for the touch coordinates in the video frames is done with a Screen2Text technique and a V2S technique.

3. The method as in claim 1, wherein provided no touch coordinates are found based on the searching for the touch coordinates in the video frames, the method is terminated.

4. The method as in claim 1, wherein identifying the touch coordinates in the video frames further comprises:
using a V2S touch coordinate identification technique; and
provided the V2S touch coordinate identification technique fails, using a Screen2Text technique to identify the touch coordinates.

5. The method as in claim 1, wherein after the identifying of the touch coordinates in the video frames, analyzing all video frames to verify which touch coordinates represent touch; and
discarding frames that do not belong to any frame group with screen interaction.

6. The method as in claim 1, wherein the generated touch coordinate groups comprise names of the video frames and the touch coordinates identified in the video frames by using a V2S technique and a Screen2Text technique.

7. The method as in claim 1, wherein the translating of the touch coordinate groups into the android actions using the heuristic rules further comprises:
grouping consecutive video frames into a touch coordinate group, comprising an initial video frame and a final video frame;
identifying the touch coordinates of the initial video frame and the touch coordinates of the final video frame of the touch coordinate group, to calculate a Euclidean distance between the touch coordinates of the initial video frame and the final video frame of the touch coordinate group;
wherein provided a number of consecutive video frames is less than five or the Euclidean distance is less than thirty units, the translation is a click action; or
wherein provided the number of consecutive video frames is greater than five or the Euclidean distance is greater than thirty units, the translation is a long click, swipe or drag-and-drop action.

8. The method as in claim 7, wherein:
the translation is a swipe action based on a number of video frames of the touch coordinate group being smaller than a minimum number of frames for a group being translated as a long click action and a distance between the touch coordinates of the initial video frame and the final video frame of the touch coordinate group being greater than 30 units,
the translation is a swipe action based on a number of frames of the touch coordinate group being greater than the minimum number of frames for the group being translated as the long click action and an Euclidean distance between the touch coordinate of the initial video frame and the final video frame of the minimum to be a long click is greater than 70 units; or
the translation is a long click action based on the number of video frames of the touch coordinate group being greater than the minimum number of frames for a group being translated as the long click action and the Euclidean distance between the touch coordinate of the initial video frame and the final video frame of the minimum to be a long click is smaller than 70 units and a distance between an initial coordinate and a final coordinate of a non-minimum to be a long click is smaller than 30 units; or
the translation is a drag-and-drop action based on the number of video frames of the group being greater than the minimum number of video frames for a group being translated as a long click action and the Euclidean distance between the touch coordinate of the initial video frame and the final video frame of the minimum to be a long click is smaller than 70 units and the distance between the initial coordinate and the final coordinate of the non-minimum to be a long click is greater than 30 units.

9. The method as in claim 1, wherein the detecting and classifying of the widgets on the key video frames further comprises:
using a find contours technique to find areas of interest with a high probability of being widgets; and
using a three-layer convolutional neural network to classify each area of interest into one of one hundred and six widget interest classes.

10. The method as in claim 1, wherein the generating of the description for the detected and classified widgets, further comprises:
using a text recognition technique based on a respective widget being a text button, text or list item, to extract text information;
using an image recognition technique, based on a respective widget being an image, card or video thumbnail, to extract image information; and
using widget assignment rules, which assign to widgets the description of a nearest horizontally or vertically aligned textual element, in case the widget does not belong either to textual or image types of widgets.

11. The method as in claim 1, wherein the user-readable test step text file comprises Android actions and widget descriptions; and
the test step file with detailed information of each step comprises preconditions for carrying out the test, including device language, a screen mode and whether a navigation bar is active or inactive, and steps that were performed in the video and translated into actions.

12. The method as in claim 1, wherein the user-readable test step text file or the test step file with the detailed information of each step, comprising:
selecting the test by widget;
identifying widgets present on a screen of the android device at a given time; and
finding and matching a widget on the screen of the android device at the given time to a widget present in the user-readable test step text file or the test step file executed.

13. The method as in claim 12, wherein the finding and matching of the widget on the screen of the android device at the given time further comprises:
comparing class and description of a widget on the screen of the android device at the given time is same as class and description of the widget present in the user-readable test step text file or the test step file that is executed.

14. The method as in claim 13, wherein based on the widget on the screen of the android device at the given time being in the same class and description as the widget present in the user-readable test step text file or the test step file that is executed, identifying widgets as being corresponding to each other.

15. The method as in claim 13, wherein based on no widget on the screen of the android device at the given time being in a same class and description as the widget present in the user-readable test step text file or the test step file that is executed, the method further comprises:
comparing the class and description of all widgets on the screen of the android device at the given time with the class and description of the widget present in the user-readable test step text file or the test step file that is executed to check semantic similarity between the classes and descriptions of the widgets on the screen of the android device at the given time and the widget present in the user-readable test step text file or the test step file that is executed, and
determining, based on a result of the semantic similarity being greater than or equal to 0.96, a widget on the screen of the android device at the given time corresponding to the widget present exists in the user-readable test step text file or the test step file that is executed.
